(19) United States
(12) Patent Application Publication
(10) Pub. No.: US 2018/0341897 A1
(43) Pub. Date: Nov. 29, 2018

(54) METHOD FOR ALLOCATING RETAIL RESOURCES

(71) Applicant: The Procter & Gamble Company, Cincinnati, OH (US)

(72) Inventor: Daniel E Ames, Morrow, OH (US)

(21) Appl. No.: 15/606,127

(22) Filed: May 26, 2017

(51) Int. Cl. G06Q 10/06

(52) U.S. Cl. CPC G06Q 10/06315

(57) ABSTRACT

In one aspect, a method for allocating retail resources, includes steps of: providing information associated with retail stores, retail shoppers, shopper attributes; and households corresponding to the retail shoppers, micro-entities, and store-level sales data for at least one SKU; defining an initial and then a refined trade area for each retail store; determining demand for at least one SKU in at least a portion of the retail stores and altering the allocation of retail resources for the SKU amongst the retail stores according to the determined demand

### FIELD OF THE INVENTION

The invention relates to the field of allocating retail resources. The invention relates particularly to the field of allocating retail resources according to local population variations.

### BACKGROUND OF THE INVENTION

Product manufacturers and retailers face an ongoing stream of choices with regard to interacting with shoppers and selling their goods and services to those shoppers. These choices regarding the assortment of products offered at a particular location, the display of the products, optimize product merchandising use, determine the details associated with special offers on products, set product pricing, the evaluation of current and past retailing efforts and the impact of social influencers are all made more critical by the increased competition between traditional brick and mortar retail locations and ecommerce locations available via the internet. At least one key to the effective allocation of retail resources is an accurate understanding of product demand at a level of detail indicating the demand for each available product at each possible retail location. What is needed is a method to increase the precision and effectiveness of the allocation of retail resources to increase the effectiveness of the use of those resources by manufacturers and retailers by more precisely understanding product demand.

### SUMMARY OF THE INVENTION

In one aspect, a method for allocating retail resources, includes steps of: providing information associated a set of with retail stores, store attributes; providing information associated with a set of retail shoppers, shopper attributes; providing information associated with a first set of households corresponding to the set of retail shoppers, household attributes; providing a set of micro-entities, wherein the set of micro-entities have attributes selected from the group consisting of: overlapping the geography of the set of trading areas, being coextensive with the geographic area of interest, being non-overlapping amongst themselves, having diverse demographics, having diverse shopping behaviors, having a second set of household attributes which are at least partially non-overlapping with the first set of household attributes, and combinations thereof; providing store-level sales data for at least one SKU; defining an initial trade area for each store according to shopper drive time to the store; defining a refined set of trade areas comprising a trade area for each of the set of retail stores according to the gathered retail store, shopper and household attributes; determining demand for at least one SKU in at least a portion of the set of retail stores according to the provided store-level sales data for the at portion of the set of retail stores, the intersection of the refined trade areas of the portion of the set of retail stores and micro-entities overlapped by the trade area of the portion of the set of retail stores; and altering the allocation of retail resources selected from the group consisting of: store-level SKU assortment, store-level shelf presence, trade-area-level pricing recommendations, store-level merchandising displays, store-level shopper centric service offerings, and combinations thereof, according to the determined demand for the at least one SKU.

### DETAILED DESCRIPTION OF THE INVENTION

A method for allocating retail resources, the method comprising steps of: providing information associated a set of with retail stores, referred to herein as store attributes. Store attributes may include: the household count, population density, population growth, average household size, percent renters, average household income, competitor count, and freeway exit count associated with each store in the store set of interest and combinations or derivatives thereof. Such attribute information may be acquired from the US Census Bureau and providers of Census data analytics and demographic information including but not limited to TomTom, Garmin, Factual, Google, Acxiom, Experian, Kantar, ComScore, Epsilon, Dunn & Bradstreet, Profitero, Transunion, Datalogix, RSi, Alteryx, InfoScout, dunnhumby, SPINS, 84.51, IRI, CPG retailers, Equifax, and Nielsen.

The method further includes the step of providing information associated with a set of retail shoppers, or shopper attributes. Shopper attributes may include: household size, household income, demographics, psychographics, purchasing patterns, online behaviors, general behaviors, and a propensity to favor or disfavor particular retailers and combinations or derivatives thereof. Such shopper data may be acquired from sources including but not limited to TomTom, Garmin, Factual, Google, Acxiom, Experian, Kantar, ComScore, Epsilon, Dunn & Bradstreet, Profitero, Transunion, Datalogix, RSi, Alteryx, InfoScout, dunnhumby, SPINS, 84.51, IRI, CPG retailers, Equifax, and Nielsen.

The method further comprises providing information associated with a first set of households corresponding to the set of retail shoppers, or household attributes. Household attributes include; average household size, rent versus own, average household income, demographics, psychographics, purchasing patterns, online behaviors, general behaviors, and a propensity to favor or disfavor particular retailers and combinations or derivatives thereof. Such household data may be acquired from sources including but not limited to TomTom, Garmin, Factual, Google, Acxiom, Experian, Kantar, ComScore, Epsilon, Dunn & Bradstreet, Profitero, Transunion, Datalogix, RSi, Alteryx, InfoScout, dunnhumby, SPINS, 84.51, IRI, CPG retailers, Equifax, and Nielsen.

The method further includes the step of providing a set of micro-entities, wherein the set of micro-entities have attributes selected from the group consisting of: overlapping the geography of the set of trading areas, being coextensive with the geographic area of interest, being non-overlapping amongst themselves, having diverse demographics, having diverse shopping behaviors, having a second set of household attributes which are at least partially non-overlapping with the first set of household attributes, and combinations thereof. US Census Block Groups, available from the US Census Bureau, exemplify the micro-entity of the method.

The method further comprises the step of: providing store-level sales data for at least one SKU. An SKU (stock keeping unit) represents an individual product offering itself represented by a single UPC barcode. A single brand name, such as PAMPERS® may have a plurality of SKUs, each individual SKU representing a different offering of the brand in terms of product size, product count, product features etc. Even a sub-brand may include numerous SKUs offered for sale at the retail level. Store-level SKU sales data may include: the availability of the SKU for purchase, the price of the SKU, promotional activities associated with the SKU at particular times—whether directed specifically to the SKU, the brand, the market category or the SKU manufacturer or retailer as a whole, SKU related merchandising activities, sales volume for the SKU, and combinations or derivatives thereof. Such data may be acquired from vendors including but not limited to TomTom, Garmin, Factual, Google, Acxiom, Experian, Kantar, ComScore, Epsilon, Dunn & Bradstreet, Profitero, Transunion, Datalogix, RSi, Alteryx, InfoScout, dunnhumby, SPINS, 84.51, IRI, CPG retailers, Equifax, and Nielsen.

The method further comprises the step of: defining an initial trade area for each store according to shopper drive time to the store. The initial trade area for each store may be defined by setting a drive time or distance and then defining the initial trade area as all households within that drive time or distance from the store. The drive time or distance may be defined as a straight-line or using mapping and traffic data to calculate a time or distance while accounting for the tortuosity of the path from a household to the store including local traffic conditions and the actual roads available to travel to the store, alone or in combination. The initial trade area may be defined using data from including but not limited to TomTom, Garmin, Factual, Google, Acxiom, Experian, Kantar, ComScore, Epsilon, Dunn & Bradstreet, Profitero, Transunion, Datalogix, RSi, Alteryx, InfoScout, dunnhumby, SPINS, 84.51, IRI, CPG retailers, Equifax, and Nielsen.

The method further comprises the step of: defining a refined set of trade areas comprising a trade area for each of the set of retail stores according to the gathered retail store, shopper and household attributes. After obtaining the store attribute data, the set of retail stores may be categorized into clusters of store based upon similarities in terms of store location and other store attributes. The clustering may be accomplished using K-means, or hierarchical clustering. After clustering, each cluster is uniquely identified using the generalized attributes of the stores within the defined cluster. Each identified cluster is then ranked for its relative attractiveness to each household in the geography of interest, all households in the USA as an example. This can be measured by calculating the sum of squared errors of each attribute relative to a prospective cluster:

Σ(a_{c1}−ah_{c1})²+(a2_{c1}−a2h_{c1})²+(an_{c1}−anh_{c1})²

where a_{c1}=attribute of cluster 1, and ah_{c1}=corresponding attribute of a household relative to cluster 1.

The probability that any particular household will shop at a particular store may then be calculated. One method for making this calculation of probability is to use Huff's Gravity Model to calculate the probability that each household will shop at a certain store. This was calculated for every household and the ten closest stores:

$${P}_{ij} = \frac{{W}_{i} / {D}_{ij}^{α}}{{\sum }_{i = 1}^{n} ( {W}_{i} / {D}_{ij }^{α} )}$$

Where: Pᵢⱼ=the probability of consumer j shopping at store i.

Wᵢ=a measure of the attractiveness of each store or site i. Created a bi-linear function based on the cluster rankings

Dᵢⱼ=the distance from consumer j to store or site i. A radial distance from each household to each location was used to determine the nearest ten stores as precise drive distance is computationally prohibitive given nearly 1 billion household/store combinations.

α=an exponent applied to distance so the probability of distant sites is dampened. It usually ranges between 1 and 2. One was used for consumer products which are inexpensive, and non-durable.

Te calculated probability may be determined for more or less than ten local stores depending upon the drive time limits and the number of local stores within the selected drive time from the household's location.

The calculated probabilities are then used to evaluate the average shopping probabilities for stores within a given trade area based upon different drive time values. Again, drive time may be calculated using map data as either straight-line distance or street level drive time with or without traffic. Drive times may be set according to an urbanicity factor which may be acquired from census data for the trade area.

A refined or final trade area for each store may then be created setting the trade area boundary based upon households having a higher probability of shopping at a given store than not shopping at the store. This refined set of trade areas for the set of retail stores will exhibit extensive overlaps in their geography. These overlaps complicate the task of defining a demand signal for products at a store-level as any particular household may lie within numerous trade areas.

To overcome this obstacle to demand signal calculation, the refined or final set of trade areas may be overlaid with a set of micro-entities. The desired features of the set of micro-entities are that the set is non-overlapping amongst its constituents, the set covers the entire geography of interest, the micro-entities are small enough that they possess unique character in terms of demographic and shopper behavior patterns, and they may be defined using attributes which are distinct from the shopper attributes used in defining the trade areas. US Census Block Groups constitute exemplary micro-entities, satisfying all desired qualities for micro-entities.

The SKU level demand associated with each micro-entity for each store, may then be calculated as a percentage of the overall demand for the SKU at that store—according to store-level point-of-sale-(POS) data for the store—SKU combination, where the calculated percentage is the area of the micro-entity within the trade area, divided by the total area of the trade area. The sum of all micro-entity demand signals for a given SKU and store trade area will sum to the total SKU demand for that store.

After the store-SKU trade-area-level and -micro-entity-level demand signals are calculated, these signals may form the basis for the allocation of retail resources.

### EXAMPLES

1. The SKU assortment for a first store having high demand signal levels for those SKUs, may be used as a model for other stores serving the same trade area. High demand SKUs from the first store may be added to the other store while low demand SKUs may be removed from the other stores assortment.

2. The demand signal information may be used to alter the market category shelf allotment in a particular store. Stores may be categorized as either high or low market-share for the category when compared to other stores in the same trade area. The relevant category offerings for the high-share stores may be expanded depending upon an evaluation of the census data associated with the Block Groups forming the trade areas of those stores. Census data indicating high baby expectancy rates may indicate a benefit from expanding the baby-care product offerings in the high-share stores for those market categories. Low-share stores identified as being in trade areas showing high category sales and also high category sales growth, may benefit from expanding the category offerings in the stores and also from altering other aspects of the store to make the stores more similar to the high share stores.

3. The demand data may be used to evaluate product pricing within a trade area. SKU pricing across the trade area may be combined with SKU market share across the trade area to determine if a pricing adjustment is warranted for the SKU.

4. The decisions regarding when and where to expand pilot programs related to new services may be supported by the demand signal evaluation. A new service may be piloted in a number of stores having diverse attributes. The performance of the program may be ranked across the stores using the demand signals for the Stores and SKUs associated with the pilot. The ranking may then be used to identify the top and bottom performing store groups and an analysis (e.g. T-tests) of the store—SKU-micro-entity—shopper attributes may be conducted to determine the driving factors behind the performance differences. The expansion of the pilot may then be focused upon stores having similar attributes and similar trade area and micro-entity attributes t increase the likelihood of acceptance and success for the service initiative. The evaluation may further be used to identify those store attributes which may need to be altered to raise the level of performance relative to the service at the low performing stores.

5. The demand signal evaluation may be used to assess the effectiveness of brand influencers on market share and sales from store to store and trade area to trade area. The trade area for each identified influencer may be determined using the trade areas of the method. The aggregate expected impact of the effort associated with the combination of influencers within a particular trade are may be determined and the demand signals may then be used to rank the performance of the relevant SKUs within the trade areas. T-tests may be used to identify the attributes which are significant to the differences in performance Principle Component Analysis of the store, cluster and shopper attributes may then identify attributes each of top and bottom performing stores have in common, and the most relevant attributes for influencing the local market for the SKUs. These attributes may then be used to identify actions to improve low performing areas by specifically targeting the most relevant influencers for the area. As an example, if a college is seen as a significant influencer for a local area or trade area, more effort may be made to market SKUs appropriate directly to the college community in the area.

6. After identifying top and bottom performing stores for at least one brand or SKU, T-tests may be used to identify the significant differences between the tiers of performance and this may be used to evaluate the relative effectiveness of different newspapers used for marketing. The aggregate demand for the neighborhoods, (Block Groups) served by the newspaper and determining the demand potential for each neighborhood by comparing the current neighborhood demand with the demand associated with the best performing neighborhood(s) which have similar attributes to that neighborhood. Newspapers may then be rated according to the percentage of their circulation area constituting areas of high demand potential. Newspapers may also be rated according to how electronic coupon friendly their circulation area is by evaluating the retailer mix of the circulation area as to electronic coupon mix to determine what percentage of trade area demand is associated with the electronic couponing retailers.

7. The demand calculations may also be used to identify neighborhoods having high demand potential. In this example, neighborhoods are ranked and categorized by brands/SKUs as top or bottom performers. T-tests may then be used to identify the attributes of significance associate with the different tiers of performance. Neighborhoods may then be evaluated in terms of their demand potential determined as the difference between the current brand/SKU demand for a neighborhood and the same demand in the best performing neighborhood having similar attributes. This information may then be used to alter the attributes identified using the T-test to reduce the differences in those significant or critical attributes between the target neighborhood and the top performing neighborhood.

8. The demand signals may be used in determining where to invest in outside the home marketing materials such as billboards. In this example, top and bottom performers are identified using the demand signals. T-tests are used to identify the significant attributes associated with performance differences, Individual neighborhoods are compared to the top performers in order to judge the demand potential between similar neighborhoods. The neighborhood data may be aggregated and a demand potential for a larger geographic area may be determined. Once a geography is identified as having a high demand potential, the drive time and map data may be used to identify high traffic areas suitable for billboard advertising placement.

The computational steps of the method may be coded in any suitable statistical data manipulation platform including but not limited to: Hadoop, Spark, Alteryx, Knime, RapidMiner, R, Python, Impala, Hive, SAS, and Esri. The method may be carried out through the creation, revision and execution of retail resourcing plans.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for allocating retail resources, the method comprising steps of:
a. providing information associated a set of with retail stores, store attributes;
b. providing information associated with a set of retail shoppers, shopper attributes;
c. providing information associated with a first set of households corresponding to the set of retail shoppers, household attributes;
d. providing a set of micro-entities, wherein the set of micro-entities have attributes selected from the group consisting of: overlapping the geography of the set of trading areas, being coextensive with the geographic area of interest, being non-overlapping amongst themselves, having diverse demographics, having diverse shopping behaviors, having a second set of household attributes which are at least partially non-overlapping with the first set of household attributes, and combinations thereof;
e. providing store-level sales data for at least one SKU;
f. defining an initial trade area for each store according to shopper drive time to the store;
g. defining a refined set of trade areas comprising a trade area for each of the set of retail stores according to the gathered retail store, shopper and household attributes;
h. determining demand for at least one SKU in at least a portion of the set of retail stores according to the provided store-level sales data for the at least a portion of the set of retail stores, the intersection of the refined trade areas of the portion of the set of retail stores and a portion of the set of micro-entities, which portion is overlapped by the trade area of the portion of the set of retail stores;
i. altering the allocation of retail resources selected from the group consisting of: store-level SKU assortment, store-level shelf presence, trade-area-level pricing recommendations, store-level merchandising displays, store-level shopper centric service offerings, and combinations thereof, according to the determined demand for the at least one SKU.

2. The method according to claim 1, wherein the store attributes are selected from the group consisting of: household count, population density, population growth, average household size, percent renters, average household income, competitor count, freeway exit count, and combinations thereof.

3. The method according to claim 1 wherein the shopper attributes are selected from the group consisting of: household size, household income, demographics, psychographics, purchasing patterns, online behaviors, general behaviors, and a propensity to favor or disfavor particular retailers and combinations or derivatives thereof.

4. The method according to claim 1 wherein the household attributes are selected from the group consisting of: average household size, rent versus own, average household income, demographics, psychographics, purchasing patterns, online behaviors, general behaviors, and a propensity to favor or disfavor particular retailers and combinations or derivatives thereof.

5. The method according to claim 1 wherein the micro-entities comprise United States Census Block Groups.

6. The method according to claim 1 wherein the store-level sales data for at least one SKU is selected from the group consisting of: the availability of the SKU for purchase, the price of the SKU, promotional activities associated with the SKU at particular times—whether directed specifically to the SKU, the brand, the market category or the SKU manufacturer or retailer as a whole, SKU related merchandising activities, sales volume for the SKU, and combinations or derivatives thereof.

7. The method according to claim 1 wherein shopper drive time is determined using a radial distance from a store location.

8. The method according to claim 1 wherein shopper drive time is determined using local map and traffic information.

9. The method according to claim 1 further comprising the step of clustering retail stores according to one or more store attributes.

10. The method according to claim 1 wherein the step of defining a refined trade area includes determining the probability that any particular household will shop at a particular store.

11. The method according to claim 1 wherein the step of defining a refined trade area includes determining the probability that any particular household will shop at a particular store for each of about ten stores closest to the particular household.

12. The method according to claim 1 wherein the step of defining a refined trade area includes using the determined probability that any particular household will shop at a particular store and the drive time selected for the store.

13. The method according to claim 1 wherein the step of altering the allocation of retail resources comprises altering the store-level SKU assortment.

14. The method according to claim 1 wherein the step of altering the allocation of retail resources comprises altering the store-level shelf presence.

15. The method according to claim 1 wherein the step of altering the allocation of retail resources comprises altering the trade-area-level pricing recommendations.

16. The method according to claim 1 wherein the step of altering the allocation of retail resources comprises altering the store-level merchandising displays.

17. The method according to claim 1 wherein the step of altering the allocation of retail resources comprises altering the store-level shopper centric service offerings.
